(19) United States
(12) Patent Application Publication
(10) Pub. No.: US 2025/0031179 A1
(43) Pub. Date: Jan. 23, 2025

(54) MECHANISM FOR REFERENCE SIGNAL TRANSMISSION ALIGNMENT

(71) Applicant: Nokia Technologies Oy, Espoo (FI)

(72) Inventors: Prajwal KESHAVAMURTHY, Munich (DE); Diomidis MICHALOPOULOS, Munich (DE); Taylan SAHIN, Munich (DE); Anastasios KAKKAVAS, Munich (DE); Stepan KUCERA, Munich (DE)

(21) Appl. No.: 18/776,616

(22) Filed: Jul. 18, 2024

Related U.S. Application Data
(60) Provisional application No. 63/514,184, filed on Jul. 18, 2023.

(51) Int. Cl. H04W 64/00; H04L 5/00; H04W 56/00

(52) U.S. Cl. CPC H04W 64/006; H04L 5/0048; H04W 56/006

(57) ABSTRACT

The present disclosure relates to reference signal transmission alignment. In particular, a target device determines whether a reference signal transmission alignment is needed among a set of anchor devices. If the reference signal transmission alignment is needed, an anchor device receives a request for the reference signal transmission alignment. The anchor device determines a transmission time window based on the request and transmits a reference signal as per the transmission time window. In this way, it can mitigate an impact of synchronization timing reference change at the target device in measurement. Consequently, the solution allows for high accuracy measurements and hence enables high accuracy sidelink positioning.

### FIELDS

Various example embodiments of the present disclosure generally relate to the field of telecommunication and in particular, to methods, devices, apparatuses and computer readable storage medium for reference signal transmission alignment.

### BACKGROUND

Location-awareness is a fundamental aspect of wireless communication networks and will enable a myriad of location-enabled services in different applications. The integration and utilization of location information in day-to-day applications will grow significantly as the technology's accuracy evolves. Many positioning technologies that depend on techniques such time of arrival (TOA), time difference of arrival (TDOA) and angle of arrival (AOA) require light-of-sight (LOS) propagation between a reference point (such as a network device) and a mobile device to be positioned. In some situations, user equipment (UE) may facilitate positioning a device. Therefore, it is worth studying on sidelink (SL) positioning.

### SUMMARY

In a first aspect of the present disclosure, there is provided an apparatus. The apparatus comprises at least one processor; and at least one memory storing instructions that, when executed by the at least one processor, cause the apparatus to: receive a request for a reference signal transmission alignment for triggering the reference signal transmission alignment with a set of devices, wherein the apparatus and the set of devices are participating in a positioning session with a target device; determine a transmission time window for the reference signal transmission alignment based on the request for the reference signal transmission alignment; and transmit, at least to the target device, a reference signal as per the transmission time window.

In a second aspect of the present disclosure, there is provided an apparatus. The apparatus comprises at least one processor; and at least one memory storing instructions that, when executed by the at least one processor, cause the apparatus to: determine whether a reference signal transmission alignment among a set of devices is needed, wherein the set of devices is participating in a positioning session with the apparatus; receive, from at least one device in the set of devices, a reference signal as per transmission time window that is determined by the at least one device based on a request for the reference signal transmission alignment; and perform a measurement using the received reference signal.

In a third aspect of the present disclosure, there is provided an apparatus. The apparatus comprises at least one processor; and at least one memory storing instructions that, when executed by the at least one processor, cause the apparatus to: receive, from a device, information indicating that a reference signal transmission alignment among a set of devices is needed, wherein the set of devices is participating in a positioning session with the device; and transmit, to the set of devices, a request for the reference signal transmission alignment for triggering the reference signal transmission alignment.

In a fourth aspect of the present disclosure, there is provided a method. The method comprises: receiving a request for a reference signal transmission alignment for triggering the reference signal transmission alignment with a set of devices, wherein the apparatus and the set of devices are participating in a positioning session with a target device; determining a transmission time window for the reference signal transmission alignment based on the request for the reference signal transmission alignment; and transmitting, at least to the target device, a reference signal as per the transmission time window.

In a fifth aspect of the present disclosure, there is provided a method. The method comprises: determining whether a reference signal transmission alignment among a set of devices is needed, wherein the set of devices is participating in a positioning session with the apparatus; receiving, from at least one device in the set of devices, a reference signal as per transmission time window that is determined by the at least one device based on a request for the reference signal transmission alignment; and performing a measurement using the received reference signal.

In a sixth aspect of the present disclosure, there is provided a method. The method comprises: receiving, from a device, information indicating that a reference signal transmission alignment among a set of devices is needed, wherein the set of devices is participating in a positioning session with the device; and transmitting, to the set of devices, a request for the reference signal transmission alignment for triggering the reference signal transmission alignment.

In a seventh aspect of the present disclosure, there is provided a first apparatus. The first apparatus comprises means for receiving a request for a reference signal transmission alignment for triggering the reference signal transmission alignment with a set of devices, wherein the first apparatus and the set of devices are participating in a positioning session with a target device; means for determining a transmission time window for the reference signal transmission alignment based on the request for the reference signal transmission alignment; and means for transmitting, at least to the target device, a reference signal as per the transmission time window.

In an eighth aspect of the present disclosure, there is provided a second apparatus. The second apparatus comprises means for determining whether a reference signal transmission alignment among a set of devices is needed, wherein the set of devices is participating in a positioning session with the second apparatus; means for receiving, from at least one device in the set of devices, a reference signal as per transmission time window that is determined by the at least one device based on a request for the reference signal transmission alignment; and means for performing a measurement using the received reference signal.

In a ninth aspect of the present disclosure, there is provided a third apparatus. The third apparatus comprises means for receiving, from a device, information indicating that a reference signal transmission alignment among a set of devices is needed, wherein the set of devices is participating in a positioning session with the device; and means for transmitting, to the set of devices, a request for the reference signal transmission alignment for triggering the reference signal transmission alignment.

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer readable medium. The computer readable medium comprises instructions stored thereon for causing an apparatus to perform at least the method according to the fifth aspect.

In a twelfth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for a reference signal transmission alignment according to example embodiments of the present disclosure;

FIG. 3A and FIG. 3B illustrate schematic diagrams of synchronization search occasions according to example embodiments of the present disclosure, respectively;

FIG. 4A and FIG. 4B illustrate schematic diagrams of transmission time windows according to example embodiments of the present disclosure, respectively;

FIG. 5 illustrates a flowchart of a method implemented at an anchor device according to some example embodiments of the present disclosure;

FIG. 6 illustrates a flowchart of a method implemented at a target device according to some example embodiments of the present disclosure;

FIG. 7 illustrates a flowchart of a method implemented at a device according to some example embodiments of the present disclosure;

FIG. 8 illustrates a simplified block diagram of a device that is suitable for implementing example embodiments of the present disclosure; and

FIG. 9 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “target terminal device/target UE” may refer to a terminal device to be positioned. The term “anchor terminal device/anchor UE” may refer to a terminal device supporting positioning of the target terminal device. For example, the anchor terminal device may transmit and/or receive reference signal(s) for positioning over sidelink interface (such as, PC5 interface). The anchor terminal device may also provide positioning related information. Functions of the anchor UE (i.e., anchor node) may be similar to uplink/downlink (UL/DL) based positioning, where gNBs serving as anchors transmit/receive reference signals to/from target UEs for positioning.

The term “sidelink positioning” used herein may prefer to positioning terminal device using reference signals transmitted over SL, i.e., PC5 interface, to obtain absolute position, relative position, or ranging information. The term “ranging” used herein may refer to a determination of the distance and/or the direction between a terminal device and another entity, e.g., anchor UE. The term “sidelink (SL) positioning reference signal (PRS)” used herein may refer to a reference signal transmitted over SL for positioning purposes. The term “SL PRS configuration” used herein may refer to a set of configured parameters of SL PRS, such as time-frequency resources including its bandwidth and periodicity, and direction-related parameters (e.g., beam direction, beam width, and number of beams). SL PRS (pre)configuration may also refer to (pre-)configured parameters of SL PRS such as transmit power. Further, the SL PRS configuration in coverage or partial coverage may be determined by the network (e.g., by location management function (LMF) or gNB), and out-of-coverage may be pre-configured and/or determined by UEs autonomously. SL synchronization consideration during anchor UE selection may also involve a roadside unit (RSU) where a UE-type or gNB-type stationary infrastructure entity supports vehicle-to-everything V2X applications. Absolute positioning may refer to estimating the UE's position in 2D/3D geographic coordinates (e.g., latitude, longitude, elevation) within a coordinate system. Additionally, relative positioning may refer to estimation of position relatively to other network elements or relatively to other UEs.

The term “reference signal transmission alignment” used herein may refer to a mechanism that adjusts transmissions of reference signals in relation to each other to achieve simultaneous transmissions of the reference signals. The term “positioning session” used herein may refer to a connection/connectivity that is used to position a device. The term “transmission time window” used herein may refer to a time-domain resource that is used for transmitting and/or receiving signal(s).

The technical specifications of 3rd Generation Partnership Project (3GPP) considers SL positioning in cases such as, for example, V2X, public safety, and commercial and industrial-internet-of-things (IIoT). Further, 3GPP considers scenarios and requirements of in-coverage, partial coverage, and out-of-coverage NR positioning use cases that focus on V2X and public safety use cases. SA1 has developed requirements in 3GPP for ranging based services and has developed positioning accuracy requirements for IIoT use cases in out-of-coverage scenarios. The positioning requirements may be captured via key-performance indices (KPIs). KPIs may include, for example, horizontal and vertical accuracy, where vertical accuracy refers to accuracy in altitude and determines the floor for indoor use cases, and to distinguish between superposed tracks for road and rail use cases (e.g., bridges). KPIs may also include positioning service availability corresponding to a percentage value of the amount of time the positioning service is delivering the required position-related data within the performance requirements, divided by the amount of time the system is expected to deliver the positioning service according to the specification in the targeted service area. The KPIs may further include positioning service latency corresponding to time elapsed between an event that triggers the determination of the position-related data and the availability of the position-related data at the system interface. Additionally, the KPIs may include a time to fix (TTFF) corresponding to an amount of time elapsed between the event triggering for the first time the determination of the position-related data, and the availability of the position related data at the position system interface. The KPIs may also include an update rate and energy consumption parameter.

SL positioning is based on the transmissions of SL PRS by multiple anchor UEs to be received by a target UE in e.g. SL TDOA approaches or SL PRS exchange between the anchor(s) and target UEs in e.g. SL (multi-)RTT approach to enable localization of the target UE and/or ranging of target UE with respect to a reference UE (e.g. anchor UE) within precise latency and accuracy requirements of the corresponding SL positioning.

In SL positioning, UEs may perform SL synchronization to obtain SL timing reference by synchronizing with a synchronization reference (SyncRef) source. In some situations, if gNB/eNB or global navigation satellite system (GNSS) are not available as a SyncRef source, a UE may select a SyncRef UE as the SyncRef source. Due to the distributed nature of SyncRef selection, different UEs may select different SyncRef sources in SL positioning scenarios.

In the DL-like SL TDOA method the target UE monitors SL PRS transmitted by the anchor UEs. In this case, the time difference of arrival of PRS with respect to a reference time is measured for position estimation. In case the SL PRSs are not simultaneously transmitted by the anchor UEs, a change in SyncRef source of the target UE during measurements from different anchors may cause inaccurate SL RSTD measurements.

Generally, a UE cannot schedule another UE. Hence, with UE-autonomous scheduling, e.g., in out-of-coverage scenarios (referred to as Scheme 2 resource allocation, which is based on NR SL resource allocation Mode 2) simultaneous transmission of SL PRS cannot be ensured. Therefore, in SL TDOA-based positioning, if there is a SyncRef change at the target UE during SL RSTD measurement from different anchor UEs, the quality of SL RSTD measurement and hence the positioning accuracy gets prone to degradations. Therefore, a solution on reference signal transmission alignment is needed.

### Example Environment

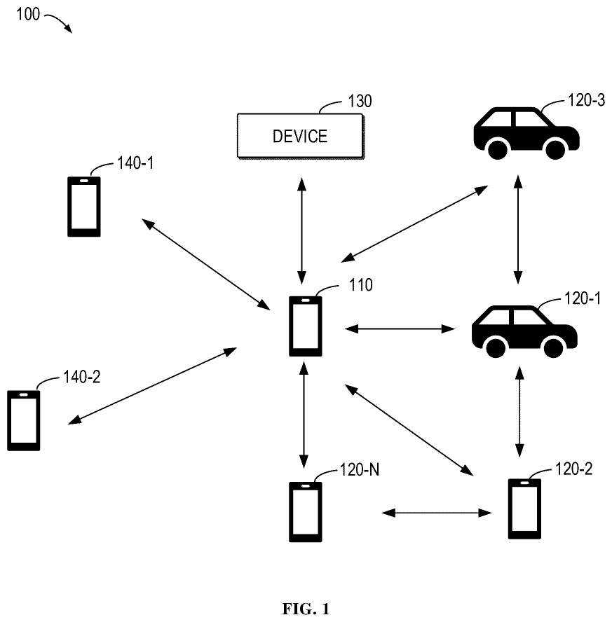

FIG. 1 illustrates an example communication environment 100 in which example embodiments of the present disclosure can be implemented. In the communication environment 100, there is a terminal device 110. The terminal device 110 may be a for example, a mobile phone, or a vehicle. The communication environment 100 includes a set of terminal devices 120-1, 120-2, . . . , and 120-N (collectively referred to as “terminal device 120”), where N may be an integer number. It is noted that the set of terminal devices 120 may include any proper number of terminal devices. The communication environment 100 also includes a device 130 which can be a server terminal device or a network node (for example, a location management function (LMF) node). As shown in FIG. 1, there may be one or more synchronization reference devices, for example, the device 140-1 and the device 140-2. By way of example, the device 140-1 may be a current synchronization reference device of the device 110 and the device 140-2 may be a candidate synchronization reference device of the device 110.

In the following, for the purpose of illustration, some example embodiments are described with the terminal device 110 operating as a target device and the terminal device 120 operating as an anchor device. However, in some example embodiments, operations described in connection with a target device may be implemented at an anchor device, and operations described in connection with an anchor device may be implemented at a target device. The terminal device 110 may be referred to as “target device 110” and the terminal device(s) 120 may be referred to as “anchor device(s) 120” hereinafter.

In some example embodiments, a link between the target device 110 and the anchor device 120 is referred to as a sidelink (SL), and a link among the anchor devices is also referred to as sidelink. In some example embodiments, the anchor device 120 is a transmitting (TX) device (or a transmitter) and the target device 110 is a receiving (RX) device (or a receiver). In some other example embodiments, the target device 110 is a TX device (or a transmitter) and the anchor device 120 is a RX device (or a receiver). It is to be understood that the number of devices and their connections shown in FIG. 1 are only for the purpose of illustration without suggesting any limitation. The communication environment 100 may include any suitable number of devices configured to implementing example embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

According to some example embodiments of the present disclosure, there is provided a solution for reference signal transmission alignment. In particular, a target device determines whether a reference signal transmission alignment is needed among a set of anchor devices. If the reference signal transmission alignment is needed, an anchor device receives a request for the reference signal transmission alignment. The anchor device determines a transmission time window based on the request and transmits a reference signal as per the transmission time window. In this way, it can mitigate an impact of synchronization timing reference change at the target device in measurement. Consequently, the solution allows for high accuracy measurements and hence enables high accuracy sidelink positioning.

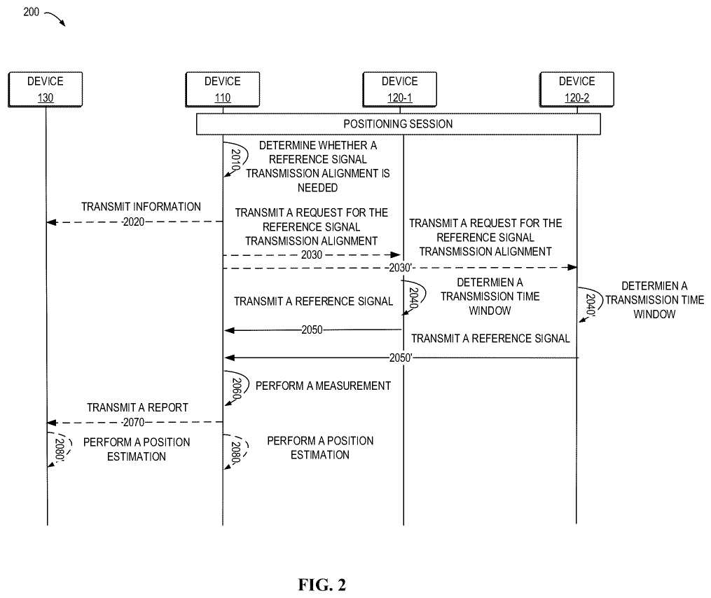

Example embodiments of the present disclosure will be described in detail below with reference to the accompanying drawings. Reference is now made to FIG. 2, which illustrates a signaling flow 200 for the reference signal transmission alignment according to some example embodiments of the present disclosure. For the purposes of discussion, the signaling flow 200 will be discussed with reference to FIG. 1, for example, by using the target device 110, the anchor device 120-1, the anchor device 120-2, and the device 130.

The anchor devices 120 (for example, the anchor devices 120-1 and 120-2) are participating in a positioning session with the target device 110. For example, the anchor devices 120-1 and 120-2 may transmit reference signals (for example, SL PRS) to the target device 110 for SL positioning. In other words, the anchor devices 120-1 and 120-2 may provide SL positioning reference signal assistance to the target device 110.

The target device 110 determines (2010) whether a reference signal transmission alignment among the anchor devices 120 is needed. In this way, it can minimize a risk of time reference change at the target device during the measurements for more/all anchor devices.

In an example embodiment, the target device 110 may determine whether the reference signal transmission alignment is needed based on a synchronization reference change likelihood (i.e., a reference time change possibility) within a duration of a sidelink measurement for reference signals from the anchor devices. For example, the target device 110 may determine a possibility of changing the synchronization reference device from the device 140-1 to the device 140-2. In this case, if the possibility is higher than a threshold (i.e., it is likely that the synchronization reference device is changed from the device 140-1 to the device 140-2), the target device 110 may determine that the reference signal transmission alignment is needed.

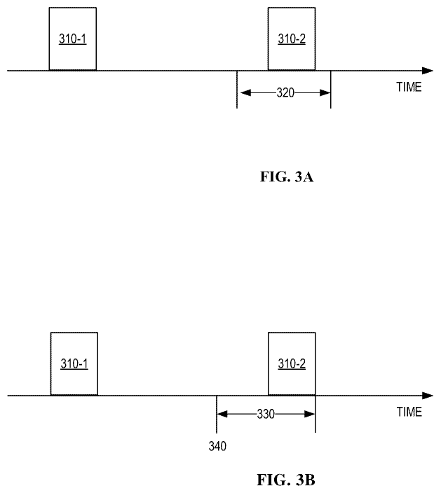

In some example embodiments, the target device 110 may determine whether a subsequent synchronization search occasion is within the duration of the sidelink measurement for reference signals from the anchor devices. The term “synchronization search occasion” used herein may refer to a time-domain resource that is used to search a synchronization reference device. If the subsequent synchronization search occasion is within the duration of the sidelink measurement, the target device 110 may determine that the reference signal alignment among the anchor devices 120 is needed. For example, as shown in FIG. 3A, the target device 110 may be configured with synchronization search occasions 310-1 and 310-2. The target device 110 may have been searched the synchronization device within the synchronization search occasion 310-1. As shown in FIG. 3A, the subsequent synchronization search occasion 310-2 may be within the duration 320 that is used to perform the sidelink measurement by the target device 110. In this case, the target device 110 may determine that the reference signal alignment among the anchor devices 120 is needed.

In some other example embodiments, the target device 110 may determine whether the subsequent synchronization search occasion is within a configured time duration (for example, within certain milliseconds). If the subsequent synchronization search occasion is within the configured time duration, the target device 110 may determine that the reference signal alignment among the anchor devices 120 is needed. For example, the target device 110 may determine whether the subsequent synchronization search occasion is within the time duration 330 from a time instance 340. As shown in FIG. 3B, the subsequent synchronization search occasion 310-2 may be within the time duration 330. In this case, the target device 110 may determine that the reference signal alignment among the anchor devices 120 is needed.

In some example embodiments, the target device 110 may determine whether a reference signal received power for the current synchronization reference device is below a first reference signal received power threshold. If the reference signal received power is below the first reference signal received power threshold, the target device 110 may determine that the reference signal alignment among the anchor devices 120 is needed. For example, the target device 110 may measure the reference signal received power for the device 140-1 which is the current synchronization reference device. In this case, if the measured reference signal received power is below the first reference signal received power threshold, the target device 110 may determine that the reference signal alignment among the anchor devices 120 is needed. Alternatively, or in addition, the target device 110 may determine whether a synchronization priority of the current synchronization reference device is below a first priority threshold. If the synchronization priority is below the first priority threshold, the target device 110 may determine that the reference signal alignment among the anchor devices 120 is needed. For example, the target device 110 may determine the synchronization priority of the device 140-1. In this case, if the synchronization priority of the device 140-1 is below the first priority threshold, the target device 110 may determine that the reference signal alignment among the anchor devices 120 is needed. Table 1 below shows examples of the different priorities of the sources (where P0 to P6 correspond to highest to lowest priorities, respectively) depending on whether it is a GNSS-based synchronization (GNSS as the highest priority) or gNB/eNB-based synchronization (gNB/eNB has the highest priority). It is noted that Table 1 is only an example not limitation.

TABLE 1

| Priority | GNSS-based | gNB/eNB-based |
|---|---|---|
| Group | synchronization | synchronization |
| P0 | GNSS | gNB/eNB |
| P1 | UE directly synchronized to | UE directly synchronized |
| | GNSS (SyncRef UE in network | to gNB/eNB (SyncRef UE |
| | coverage and directly | directly synchronized to |
| | synchronized to GNSS, | gNB/eNB, i.e., with |
| | i.e., with inCoverage = 1 | inCoverage = 1 |
| | and SLSS ID = {0}) | and with SLSS ID = |
| | | {1, . . . , 335}) |
| P2 | UE indirectly synchronized | UE indirectly synchronized |
| | to GNSS (SyncRef UE out of | to gNB/eNB (SyncRef UE out |
| | GNSS/network coverage and | of GNSS/network coverage |
| | one hop away from GNSS, | and one hop away from a |
| | i.e., with inCoverage = | gNB/eNB, i.e., with |
| | 0 and SLSS ID = | inCoverage = 0 and |
| | {0}) | with SLSS ID = |
| | | {1, . . . , 335}) |
| P3 | gNB/eNB | GNSS |
| P4 | UE directly synchronized to | UE directly synchronized to |
| | gNB/eNB (SyncRef UE directly | GNSS (SyncRef UE directly |
| | synchronized to a gNB/eNB, | synchronized to GNSS, i.e., |
| | i.e., with inCoverage = | with inCoverage = 1 and |
| | 1 and with SLSS | SLSS ID = {0}) |
| | ID = {1, . . . , 335}) | |
| P5 | UE indirectly synchronized to | UE indirectly synchronized |
| | gNB/eNB (SyncRef UE out of | to GNSS (SyncRef UE out |
| | GNSS/network coverage and | of GNSS/network coverage |
| | one hop away from a gNB/eNB, | and one hop away from |
| | i.e., with inCoverage = | GNSS, i.e., with |
| | 0 and with SLSS ID = | inCoverage = 0 and |
| | {1, . . . , 335}) | SLSS ID = {0}) |

| | |
|---|---|
| P6 | the remaining UEs have the lowest |
| | priority (including UE's own internal |
| | clock; SyncRef UE out of GNSS/network |
| | coverage and two or more hops away from a |
| | gNB/eNB or GNSS, i.e., with |
| | inCoverage = 0 and with |
| | SLSS ID = {336, |
| | 337, . . . , 671}) |

For example, if the synchronization priority of the device 140-1 is “P6” and the first priority threshold is “P5”, the target device 110 may determine that the reference signal alignment among the anchor devices 120 is needed.

In some other example embodiment, the target device 110 may determine whether a reference signal received power for a candidate synchronization reference device is above a second reference signal received power threshold. For example, the second reference signal received power threshold may be same as the first reference signal received power threshold. Alternatively, the second reference signal received power threshold may be different from the first reference signal received power threshold. If the reference signal received power is above the second reference signal received power threshold, the target device 110 may determine that the reference signal alignment among the anchor devices 120 is needed. For example, the target device 110 may measure the reference signal received power for the device 140-2 which is the candidate synchronization reference device. In this case, if the measured reference signal received power is above the second reference signal received power threshold, the target device 110 may determine that the reference signal alignment among the anchor devices 120 is needed. Alternatively, or in addition, the target device 110 may determine whether a synchronization priority of the candidate synchronization reference device is above a second priority threshold. If the synchronization priority is above the second priority threshold, the target device 110 may determine that the reference signal alignment among the anchor devices 120 is needed. For example, the target device 110 may determine the synchronization priority of the device 140-2. In this case, if the synchronization priority of the device 140-2 is above the second priority threshold, the target device 110 may determine that the reference signal alignment among the anchor devices 120 is needed. For example, if the synchronization priority of the device 140-2 is “P4” and the second priority threshold is “P5”, the target device 110 may determine that the reference signal alignment among the anchor devices 120 is needed.

In an example embodiment, the target device 110 may determine whether the reference signal alignment among the anchor devices 120 is needed based on a clock-drift performance of the target device 110. The term “clock-drift performance” may refer to how well an internal clock is performed. For example, if the clock-drift performance is below a performance threshold (i.e., the clock-drift performance is poor), the target device 110 may determine that the reference signal alignment among the anchor devices 120 is needed.

In another example embodiment, the target device 110 may determine an expected difference between a first time reference before a change of a time reference and a second time reference after the change of the time reference. If the expected difference is to be above a difference threshold, the target device 110 may determine that the reference signal alignment among the anchor devices 120 is needed. For example, the target device 110 may determine the first time reference when the synchronization device is the device 140-1 and determine the second time reference when the synchronization device is the device 140-2. The target device 110 may whether the difference between the first and second time references is above the difference threshold.

In an example embodiment, in case there is the device 130 that is a controlling entity (e.g., LMF or Server UE), the target device 110 may send reference signal transmission alignment trigger or indicate its SyncRef change likelihood and clock-drift characteristics to the device 130. Then the device 130 may take an action to achieve aligned reference signal transmissions between the anchor devices. For example, if the reference signal transmission alignment devices is needed, the target device 110 may transmit (2020) information indicating that the reference signal transmission alignment devices is needed to the device 130. In this case, the device 130 may transmit a request for the reference signal transmission alignment for triggering the reference signal transmission alignment to one or more anchor devices 120.

Alternatively, the target device 110 may transmit the request for the reference signal transmission alignment for triggering the reference signal transmission alignment to one or more anchor devices 120. For example, as shown in FIG. 2, the target device 110 may transmit (2030) the request for the reference signal transmission alignment to the anchor device 120-1 and transmit (2030′) the request for the reference signal transmission alignment to the anchor device 120-2. In other words, the anchor device(s) 120 may receive the request for the reference signal transmission alignment from the target device 110 or the device 130. It is noted that the order of the transmission (2030) and transmission (2030′) shown in FIG. 2 is only an example not limitation.

In an example embodiment, the request for the reference signal transmission alignment may be transmitted over a sidelink positioning protocol message. Alternatively, sidelink control information may include the request for the reference signal transmission alignment.

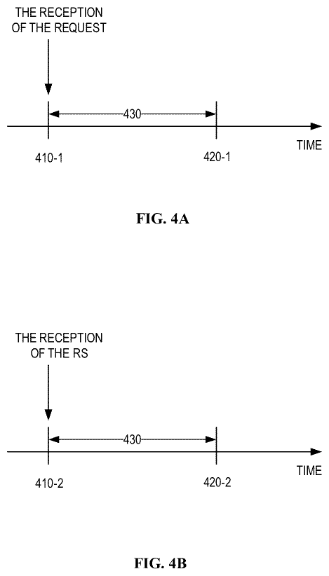

The anchor device(s) 120 may determine a transmission time window based on the request for the reference signal transmission alignment. By way of example, as shown in FIG. 4A and FIG. 4B, the anchor device(s) 120 may determine the transmission time window 430 based on the request. For example, the anchor device 120-1 may determine (2040) the transmission time window based on the request for the reference signal transmission alignment. The anchor device 120-2 may determine (2040′) the transmission window based on the request for the reference signal transmission alignment. It is noted that the order of the determination (2040) and the determination (2040′) shown in FIG. 2 is only an example not limitation.

In some example embodiments, the request for the reference signal transmission alignment may include an indication for triggering the reference signal transmission alignment. Alternatively, or in addition, the request for the reference signal transmission alignment may include a time reference point for the transmission time window. The request for the reference signal transmission alignment may also include time window information indicating a start point and an end point of the transmission time window from the time reference point. The anchor device(s) 120 may determine an actual start point and an actual end point of the transmission time window based on the time window information and the time reference point. For example, as shown in FIG. 4A, the anchor device(s) 120 may determine the actual start point (410-1) and the actual end point (420-1) of the transmission time window (430) based on the time window information and the time reference point (410-1). The anchor device(s) 120 may determine the actual start point (410-2) and the actual end point (420-2) of the transmission time window (430) based on the time window information and the time reference point (410-2).

In an example embodiment, the time reference point in the request may include a reception time point of the request for the reference signal transmission alignment. In this case, the anchor device(s) 120 may determine the actual start point of the transmission time window as the reception time point of the request for the reference signal transmission alignment. For example, as shown in FIG. 4A, if the anchor device(s) 120 receives the request at the time point 410-1, the reception time point 410-1 may be determined as the actual start point of the transmission time window. In some other example embodiments, the sidelink positioning protocol message may be used to indicate the need of the reference signal transmission alignment (i.e., the request) and the sidelink control information may be used as the time reference point for the transmission time window. In this case, if the sidelink control information is received at the time point 410-1, the reception time point 410-1 may be determined as the actual start point of the transmission time window.

Alternatively, the time reference point includes a reception time point of a sidelink signal from one or more anchor device(s) 120. In this case, the request for the reference signal transmission alignment may also include source identity information of the anchor devices 120. For example, the request may include identities of the anchor device 120-1, 120-2 and 120-3. Alternatively, or in addition, the request for the reference signal transmission alignment may include destination identity information used by the anchor devices 120. For example, the request for the reference signal transmission alignment may include an identity of the target device 110.

In an example embodiment, the anchor device(s) 120 may broadcast a sidelink signal including its identity and/or the identity of the target device 110. For example, the anchor device 120-1 may broadcast the sidelink signal that includes one or more of: the identity of the anchor device 120-1 or the identity of the target device 110 to other anchor devices, for example, the anchor device 120-2 and/or the anchor device 120-3. In some embodiments, the sidelink signal may be a SL PRS. Alternatively, the sidelink signal may be sidelink control information.

Alternatively, the anchor device(s) 120 may monitor the sidelink signal (for example, SL PRS or sidelink control information) from the one or more anchor devices using at least one of the source identity information or the destination identity information. For example, the anchor device 120-2 may monitor the sidelink signal from another anchor device (for example, the anchor device 120-1). The sidelink signal may include one or more of: the identity of the anchor device 120-1 or the identity of the target device 110. In this case, the anchor device 120-2 may determine the actual start point of the transmission time window as the reception time point of the signal from the other anchor device. For example, as shown in FIG. 4B, if the anchor device 120-2 receives the sidelink signal from the anchor device 120-1 at the time point 410-2, the reception time point 410-2 may be determined as the actual start point of the transmission time window.

The anchor device(s) 120 transmits a reference signal (for example, SL PRS) at least to the target device 110 as per the transmission time window (for example, the transmission time window 430). In other words, the target device 110 may receive the reference signal from one or more anchor devices (for example, the anchor device 120-1 and the anchor device 120-2) within the transmission time window. By way of example, the anchor device(s) 120 may broadcast the reference signal to the target device 110 and other anchor devices. For example, as shown in FIG. 2, the anchor device 120-1 may transmit (2050) the reference signal at least to the target device 110 within the transmission time window 430. The anchor device 120-2 may transmit (2050′) the reference signal at least to the target device 110 within the transmission time window 430. It is noted that the order of the transmission (2050) and transmission (2050′) shown in FIG. 2 is only an example not limitation.

The anchor device(s) 120 may obtain a configuration of resource selection window as per the transmission time window. In an example embodiment, the anchor device(s) 120 may use this time constraint (i.e., the transmission time window) at its physical layer and medium access control (MAC) layer for sidelink resource selection within the transmission time window. In this case, a physical layer sidelink resource selection window may be configured as per the time window.

The target device 110 performs (2060) a measurement on using received one or more reference signals from the anchor device(s) 120. For example, the target device 110 may a SL reference signal time difference (RSTD) measurement using the received one or more reference signals. By way of example, the target device 110 may measure a time difference of arrival of the reference signals from the anchor devices 120-1 and 120-2.

In some example embodiments, the target device 110 may perform (2080) a position estimation of the target device 110 based on the measurement (i.e., the measurement result). Alternatively, the target device 110 may transmit (2070) a report indicating the measurement (i.e., the measurement result) of the received reference signal to the device 130. In this case, the device 130 may perform (2080′) the position estimation of the target device 110 based on the measurement indicated in the report.

In a further embodiment, in in-coverage scenarios, the device 130 may indicate a transmission time window/relative time requirement to different gNBs, e.g., serving different anchor terminal devices so as to achieve timely and aligned resource allocation. For example, the device 130 may transmit, to another set of network devices of the anchor devices 120, further information indicating a requirement on a transmission time window for the reference signal transmission alignment. Alternatively, the device 130 may indicate required timing to anchor devices 120, which indicate to their own serving gNBs for SL resource allocation. For example, the device 130 may transmit, to the anchor devices 120, the further information indicating the requirement on the transmission time window for the reference signal transmission alignment.

According to embodiments described with reference to FIG. 2, a target device determines a need for reference signal transmission alignment among anchor devices based on at least its synchronization reference change likelihood and/or clock-drift characteristics. The target device triggers the reference signal transmission alignment between anchor devices by sending an “alignment trigger” to its anchor devices. Anchor devices align their reference signal transmissions as per the received trigger. In this way, it can mitigate the impact of synchronization timing reference change at target device in the measurement. Consequently, the solution allows for high accuracy measurements and hence enables high accuracy sidelink positioning.

### Example Methods

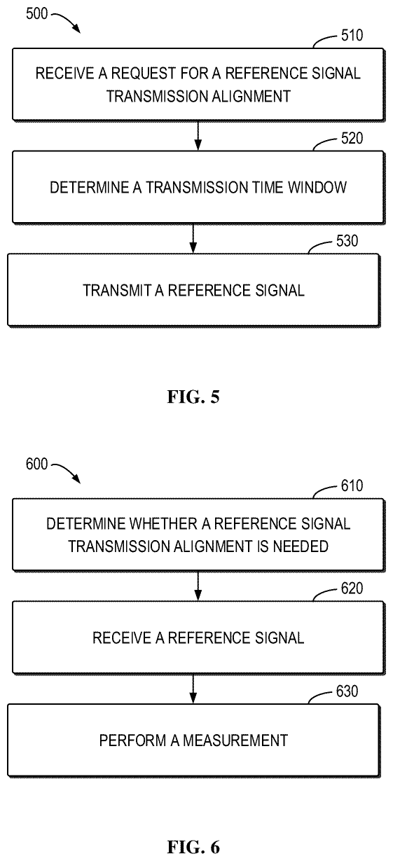

FIG. 5 shows a flowchart of an example method 500 implemented at an anchor device in accordance with some example embodiments of the present disclosure. For the purpose of discussion, the method 500 will be described from the perspective of the anchor device 120 in FIG. 1.

At block 510, the anchor device 120 obtains a request for a reference signal transmission alignment for triggering the reference signal transmission alignment with a set of devices 120. The anchor device 120 and the set of devices 120 are participating in a positioning session with a target device 110.

At block 520, the anchor device 120 determines a transmission time window for the reference signal transmission alignment based on the request for the reference signal transmission alignment.

At block 530, the anchor device 120 transmits, at least to the target device 110, a reference signal as per the transmission time window. In some example embodiments, the reference signal is a sidelink positioning reference signal.

In some example embodiments, the request for the reference signal transmission alignment is received in at least one of: a sidelink positioning protocol message, or sidelink control information. In some example embodiments, the request for the reference signal transmission alignment comprises at least one of: an indication for triggering the reference signal transmission alignment, a time reference point for the transmission time window, or time window information indicating a start point and an end point of the transmission time window from the time reference point.

In some example embodiments, the method 500 further comprises: determining an actual start point and an actual end point of the transmission time window based on the time window information and the time reference point. In some example embodiments, the method 500 further comprises: determining the actual start point of the transmission time window as the reception time point of the request for the reference signal transmission alignment.

In some example embodiments, the time reference point comprises a reception time point of a sidelink signal from one or more devices of the set of devices, and the request for the reference signal transmission alignment further comprises at least one of:
source identity information of the set of devices, or destination identity information used by the set of devices.

In some example embodiments, the method 500 further comprises: monitoring the sidelink signal from the one or more devices using at least one of the source identity information or the destination identity information; and based on a determination that the sidelink signal is received, determining the actual start point of the transmission time window as the reception time point of the signal from the one or more devices.

In some example embodiments, the method 500 further comprises: broadcasting, to the set of devices, another sidelink signal comprising one of: an identity of the apparatus or an identity of the target device. In some example embodiments, the method 500 further comprises: obtaining a configuration of resource selection window as per the transmission time window.

In some example embodiments, the method 500 further comprises: receiving the request for the reference signal transmission alignment from the target device; or receiving the request for the reference signal transmission alignment from another device that is a server terminal device or a network node.

FIG. 6 shows a flowchart of an example method 600 implemented at a target device in accordance with some example embodiments of the present disclosure. For the purpose of discussion, the method 600 will be described from the perspective of the target device 110 in FIG. 1.

At block 610, the target device 110 determines whether a reference signal transmission alignment among a set of devices is needed. the set of devices is participating in a positioning session with the apparatus.

At block 620, the target device 110 receives, from at least one device in the set of devices, a reference signal as per transmission time window. The transmission time window is determined by the at least one device based on a request for the reference signal transmission alignment.

At block 630, the target device 110 performs a measurement using the received reference signal. In some example embodiments, the reference signal is a sidelink positioning reference signal.

In some example embodiments, the method 600 further comprises: determining whether the reference signal alignment among the set of devices is needed, based on a reference time change possibility within a duration of a sidelink measurement for reference signals from the set of devices.

In some example embodiments, the method 600 further comprises: determining that the reference signal alignment among the set of devices is needed, in accordance with a determination that at least one of the followings is fulfilled: a next synchronization search occasion at the apparatus is within a duration of a sidelink measurement for reference signals from the set of devices, the next synchronization search occasion at the apparatus is within a configured time duration, a reference signal received power for a current synchronization reference device of the apparatus is below a first reference signal received power threshold, a synchronization priority of the current synchronization reference device is below a first priority threshold, a reference signal received power for a candidate synchronization reference device of the apparatus is above a second reference signal received power threshold, a synchronization priority of the candidate synchronization reference device is above a second priority threshold, a clock-drift performance at the apparatus is below a performance threshold, or a difference between a first time reference before a change of a time reference and a second time reference after the change of the time reference is to be above a difference threshold.

In some example embodiments, the method 600 further comprises: based on a determination that the reference signal transmission alignment among the set of devices is needed, transmitting, to the set of devices, the request for the reference signal transmission alignment for triggering the reference signal transmission alignment. In some example embodiments, the request for the reference signal transmission alignment is transmitted in at least one of: a sidelink positioning protocol message, or sidelink control information.

In some example embodiments, the method 600 further comprises: based on a determination that the reference signal transmission alignment among the set of devices is needed, informing another device that the reference signal transmission alignment among the set of devices is needed.

In some example embodiments, the request for the reference signal transmission alignment comprises at least one of: an indication for triggering the reference signal transmission alignment, a time reference point for the transmission time window, or time window information indicating a start point and an end point of the transmission time window from the time reference point.

In some example embodiments, the time reference point comprises a reception time point of the request for the reference signal transmission alignment, or wherein the time reference point comprises a reception time point of a sidelink signal from one or more devices of the set of devices.

In some example embodiments, the request for the reference signal transmission alignment further comprises at least one of: source identity information of the set of devices, or destination identity information used by the set of devices.

In some example embodiments, the method 600 further comprises: performing a positioning estimation of the apparatus based on the measurement of the received reference signal. In some example embodiments, the method 600 further comprises: transmitting, to the other device, a report indicating the measurement of the received reference signal.

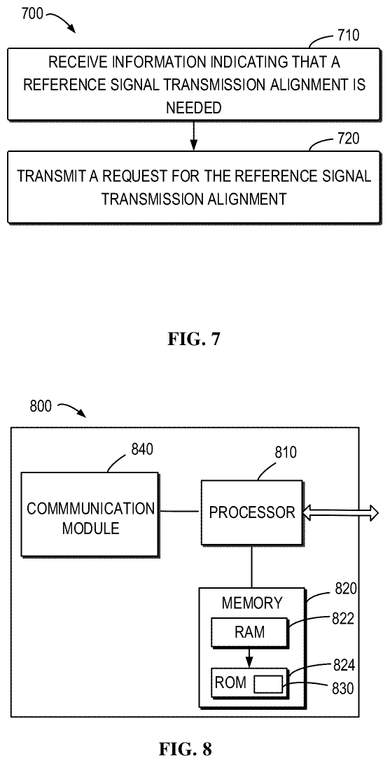

FIG. 7 shows a flowchart of an example method 700 implemented at a device in accordance with some example embodiments of the present disclosure. For the purpose of discussion, the method 700 will be described from the perspective of the device 130 in FIG. 1.

At block 710, the device 130 receives, from a device, information indicating that a reference signal transmission alignment among a set of devices is needed. The set of devices is participating in a positioning session with the device.

At block 720, the device 130 transmits, to the set of devices, a request for the reference signal transmission alignment for triggering the reference signal transmission alignment. In some example embodiments, the method 700 further comprises: receiving, from the device, a report indicating a measurement that is performed by the device based on a reference signal received from at least one device of the set of devices; and
performing a position estimation of the device based on the measurement.

In some example embodiments, the method 700 further comprises: transmitting, to another set of network devices of the set of devices, further information indicating a requirement on a transmission time window for the reference signal transmission alignment. In some example embodiments, the method 700 further comprises: transmitting, to the set of devices, the further information indicating the requirement on the transmission time window for the reference signal transmission alignment.

In some example embodiments, the apparatus comprises a server terminal device or a location management function node, the device comprises a target terminal device, and the set of devices comprises a set of anchor terminal devices.

### Example Apparatus, Device and Medium

In some example embodiments, a first apparatus capable of performing any of the method 500 (for example, the target device 110 in FIG. 1) may comprise means for performing the respective operations of the method 500. The means may be implemented in any suitable form. For example, the means may be implemented in a circuitry or software module. The first apparatus may be implemented as or included in the target device 110 in FIG. 1.

In some example embodiments, the first apparatus comprises means for receiving a request for a reference signal transmission alignment for triggering the reference signal transmission alignment with a set of devices, wherein the apparatus and the set of devices are participating in a positioning session with a target device; means for determining a transmission time window for the reference signal transmission alignment based on the request for the reference signal transmission alignment; and means for transmitting, at least to the target device, a reference signal as per the transmission time window.

In some example embodiments, the request for the reference signal transmission alignment is received in at least one of: a sidelink positioning protocol message, or sidelink control information.

In some example embodiments, the request for the reference signal transmission alignment comprises at least one of: an indication for triggering the reference signal transmission alignment, a time reference point for the transmission time window, or time window information indicating a start point and an end point of the transmission time window from the time reference point.

In some example embodiments, the first apparatus further comprises: means for determining an actual start point and an actual end point of the transmission time window based on the time window information and the time reference point.

In some example embodiments, the time reference point comprises a reception time point of the request for the reference signal transmission alignment, and wherein the first apparatus further comprises: means for determining the actual start point of the transmission time window as the reception time point of the request for the reference signal transmission alignment.

In some example embodiments, the time reference point comprises a reception time point of a sidelink signal from one or more devices of the set of devices, and wherein the request for the reference signal transmission alignment further comprises at least one of: source identity information of the set of devices, or destination identity information used by the set of devices.

In some example embodiments, the first apparatus further comprises: means for monitoring the sidelink signal from the one or more devices using at least one of the source identity information or the destination identity information; and means for based on a determination that the sidelink signal is received, determining the actual start point of the transmission time window as the reception time point of the signal from the one or more devices.

In some example embodiments, the first apparatus further comprises: means for broadcasting, to the set of devices, another sidelink signal comprising one of: an identity of the apparatus or an identity of the target device.

In some example embodiments, the first apparatus further comprises: means for obtaining a configuration of resource selection window as per the transmission time window.

In some example embodiments, the first apparatus further comprises: means for receiving the request for the reference signal transmission alignment from the target device; or means for receiving the request for the reference signal transmission alignment from another device that is a server terminal device or a network node.

In some example embodiments, the reference signal is a sidelink positioning reference signal.

In some example embodiments, the apparatus comprises an anchor terminal device, the target device comprises a target terminal device, and the set of devices comprises a set of anchor terminal devices.

In some example embodiments, the first apparatus further comprises means for performing other operations in some example embodiments of the method 500 or the target device 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the anchor device 120 in FIG. 1) may comprise means for performing the respective operations of the method 600. The means may be implemented in any suitable form. For example, the means may be implemented in a circuitry or software module. The second apparatus may be implemented as or included in the anchor device 120 in FIG. 1.

In some example embodiments, the second apparatus comprises means for determining whether a reference signal transmission alignment among a set of devices is needed, wherein the set of devices is participating in a positioning session with the apparatus; means for receiving, from at least one device in the set of devices, a reference signal as per transmission time window that is determined by the at least one device based on a request for the reference signal transmission alignment; and means for performing a measurement using the received reference signal.

In some example embodiments, the second apparatus further comprises: means for determining whether the reference signal alignment among the set of devices is needed, based on a reference time change possibility within a duration of a sidelink measurement for reference signals from the set of devices.

In some example embodiments, the second apparatus further comprises: means for determining that the reference signal alignment among the set of devices is needed, in accordance with a determination that at least one of the followings is fulfilled: a next synchronization search occasion at the apparatus is within a duration of a sidelink measurement for reference signals from the set of devices, the next synchronization search occasion at the apparatus is within a configured time duration, a reference signal received power for a current synchronization reference device of the apparatus is below a first reference signal received power threshold, a synchronization priority of the current synchronization reference device is below a first priority threshold, a reference signal received power for a candidate synchronization reference device of the apparatus is above a second reference signal received power threshold, a synchronization priority of the candidate synchronization reference device is above a second priority threshold, a clock-drift performance at the apparatus is below a performance threshold, or a difference between a first time reference before a change of a time reference and a second time reference after the change of the time reference is to be above a difference threshold.

In some example embodiments, the second apparatus further comprises: means for based on a determination that the reference signal transmission alignment among the set of devices is needed, transmitting, to the set of devices, the request for the reference signal transmission alignment for triggering the reference signal transmission alignment.

In some example embodiments, the request for the reference signal transmission alignment is transmitted in at least one of: a sidelink positioning protocol message, or sidelink control information.

In some example embodiments, the second apparatus further comprises: means for based on a determination that the reference signal transmission alignment among the set of devices is needed, informing another device that the reference signal transmission alignment among the set of devices is needed.

In some example embodiments, the request for the reference signal transmission alignment comprises at least one of: an indication for triggering the reference signal transmission alignment, a time reference point for the transmission time window, or means for timing window information indicating a start point and an end point of the transmission time window from the time reference point.

In some example embodiments, the time reference point comprises a reception time point of the request for the reference signal transmission alignment, or wherein the time reference point comprises a reception time point of a sidelink signal from one or more devices of the set of devices.

In some example embodiments, the request for the reference signal transmission alignment further comprises at least one of: source identity information of the set of devices, or destination identity information used by the set of devices.

In some example embodiments, the second apparatus further comprises: means for performing a positioning estimation of the apparatus based on the measurement of the received reference signal.

In some example embodiments, the second apparatus further comprises: means for transmitting, to the other device, a report indicating the measurement of the received reference signal.

In some example embodiments, the reference signal is a sidelink positioning reference signal.

In some example embodiments, the apparatus comprises a target terminal device, and the set of devices comprises a set of anchor terminal devices.

In some example embodiments, the second apparatus further comprises means for performing other operations in some example embodiments of the method 600 or the anchor device 120. In some example embodiments, the means comprises at least one processor; and at least one memory storing instructions that, when executed by the at least one processor, cause the performance of the second apparatus.

In some example embodiments, a third apparatus capable of performing any of the method 700 (for example, the device 130 in FIG. 1) may comprise means for performing the respective operations of the method 700. The means may be implemented in any suitable form. For example, the means may be implemented in a circuitry or software module. The third apparatus may be implemented as or included in the device 130 in FIG. 1.

In some example embodiments, the third apparatus comprises means for receiving, from a device, information indicating that a reference signal transmission alignment among a set of devices is needed, wherein the set of devices is participating in a positioning session with the device; and means for transmitting, to the set of devices, a request for the reference signal transmission alignment for triggering the reference signal transmission alignment.

In some example embodiments, the third apparatus further comprises: means for receiving, from the device, a report indicating a measurement that is performed by the device based on a reference signal received from at least one device of the set of devices; and means for performing a position estimation of the device based on the measurement.

In some example embodiments, the third apparatus further comprises: means for transmitting, to another set of network devices of the set of devices, further information indicating a requirement on a transmission time window for the reference signal transmission alignment; or means for transmitting, to the set of network devices, the further information indicating the requirement on the transmission time window for the reference signal transmission alignment.

In some example embodiments, the apparatus comprises a server terminal device or a location management function node, the device comprises a target terminal device, and the set of devices comprises a set of anchor terminal devices.

In some example embodiments, the third apparatus further comprises means for performing other operations in some example embodiments of the method 700 or the device 130. In some example embodiments, the means comprises at least one processor; and at least one memory storing instructions that, when executed by the at least one processor, cause the performance of the third apparatus.

FIG. 8 is a simplified block diagram of a device 800 that is suitable for implementing example embodiments of the present disclosure. The device 800 may be provided to implement a communication device, for example, the target device 110 or the anchor device 120 or the device 130 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 2 to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

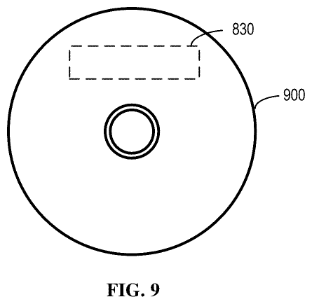

FIG. 9 shows an example of the computer readable medium 900 which may be in form of CD, DVD or other optical storage disk. The computer readable medium 900 has the program 830 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-61. (canceled)

62. An apparatus comprising:
at least one processor; and
at least one memory storing instructions that, when executed by the at least one processor, cause the apparatus to:
determine a reference signal transmission alignment among a set of devices is needed, wherein the set of devices is participating in a positioning session with the apparatus, and wherein determining that the reference signal transmission alignment among the set of devices is needed based on the following:
a next synchronization search occasion at the apparatus is within a duration of a sidelink measurement for reference signals from the set of devices,
the next synchronization search occasion at the apparatus is within a configured time duration,
a reference signal received power for a current synchronization reference device of the apparatus is below a first reference signal received power threshold,
a synchronization priority of the current synchronization reference device is below a first priority threshold,
a reference signal received power for a candidate synchronization reference device of the apparatus is above a second reference signal received power threshold,
a synchronization priority of the candidate synchronization reference device is above a second priority threshold,
a clock-drift performance at the apparatus is below a performance threshold, and
a difference between a first time reference before a change of a time reference and a second time reference after the change of the time reference is to be above a difference threshold;
based on a determination that the reference signal transmission alignment among the set of devices is needed, transmit, to the set of devices, a request for the reference signal transmission alignment for triggering the reference signal transmission alignment wherein the request for the reference signal transmission alignment is transmitted in a sidelink positioning protocol message and a sidelink control information, and wherein the request for the reference signal transmission alignment comprises: an indication for triggering the reference signal transmission alignment, a time reference point for a transmission time window, and time window information indicating a start point and an end point of the transmission time window from the time reference point;
receive, from at least one device in the set of devices, a reference signal as per transmission time window that is determined by the at least one device based on a request for the reference signal transmission alignment; and
perform a measurement using the received reference signal.

63. The apparatus of claim 62, wherein determining that the reference signal alignment among the set of devices is needed, is based further on a reference time change possibility within a duration of a sidelink measurement for reference signals from the set of devices.

64. The apparatus of claim 63, wherein the apparatus is caused to:
based on the determination that the reference signal transmission alignment among the set of devices is needed, inform another device that the reference signal transmission alignment among the set of devices is needed.

65. The apparatus of claim 64, wherein the time reference point comprises a reception time point of the request for the reference signal transmission alignment, or
wherein the time reference point comprises a reception time point of a sidelink signal from one or more devices of the set of devices.

66. The apparatus of claim 65, wherein the request for the reference signal transmission alignment further comprises:
source identity information of the set of devices, and
destination identity information used by the set of devices.

67. The apparatus of claim 66, wherein the apparatus is further caused to:
perform a positioning estimation of the apparatus based on the measurement of the received reference signal.

68. The apparatus of claim 67, wherein the apparatus is further caused to:
transmit, to another device, a report indicating the measurement of the received reference signal.

69. A system comprising:
an apparatus comprising:
at least one processor; and
at least one memory storing instructions that, when executed by the at least one processor, cause the apparatus to:
determine a reference signal transmission alignment among a set of devices is needed, wherein the set of devices is participating in a positioning session with the apparatus, and wherein determining that the reference signal transmission alignment among the set of devices is needed based on the following:
a next synchronization search occasion at the apparatus is within a duration of a sidelink measurement for reference signals from the set of devices,
the next synchronization search occasion at the apparatus is within a configured time duration,
a reference signal received power for a current synchronization reference device of the apparatus is below a first reference signal received power threshold,
a synchronization priority of the current synchronization reference device is below a first priority threshold,
a reference signal received power for a candidate synchronization reference device of the apparatus is above a second reference signal received power threshold,
a synchronization priority of the candidate synchronization reference device is above a second priority threshold,
a clock-drift performance at the apparatus is below a performance threshold, and
a difference between a first time reference before a change of a time reference and a second time reference after the change of the time reference is to be above a difference threshold;
based on a determination that the reference signal transmission alignment among the set of devices is needed, transmit, to the set of devices, a request for the reference signal transmission alignment for triggering the reference signal transmission alignment wherein the request for the reference signal transmission alignment is transmitted in a sidelink positioning protocol message and a sidelink control information, and wherein the request for the reference signal transmission alignment comprises: an indication for triggering the reference signal transmission alignment, a time reference point for a transmission time window, and time window information indicating a start point and an end point of the transmission time window from the time reference point;
receive, from at least one device in the set of devices, a reference signal as per transmission time window that is determined by the at least one device based on a request for the reference signal transmission alignment; and
perform a measurement using the received reference signal.

70. The system of claim 69, wherein determining that the reference signal alignment among the set of devices is needed, is based further on a reference time change possibility within a duration of a sidelink measurement for reference signals from the set of devices.

71. The system of claim 70, wherein the apparatus is caused to:
based on the determination that the reference signal transmission alignment among the set of devices is needed, inform another device that the reference signal transmission alignment among the set of devices is needed.

72. The system of claim 71, wherein the time reference point comprises a reception time point of the request for the reference signal transmission alignment, or
wherein the time reference point comprises a reception time point of a sidelink signal from one or more devices of the set of devices.

73. The system of claim 72, wherein the request for the reference signal transmission alignment further comprises:
source identity information of the set of devices, and
destination identity information used by the set of devices.

74. The system of claim 73, wherein the apparatus is further caused to:
perform a positioning estimation of the apparatus based on the measurement of the received reference signal.

75. The system of claim 74, wherein the apparatus is further caused to:
transmit, to another device, a report indicating the measurement of the received reference signal.

76. A method comprising:
determining a reference signal transmission alignment among a set of devices is needed, wherein the set of devices is participating in a positioning session with an apparatus, and wherein determining that the reference signal transmission alignment among the set of devices is needed based on the following:
a next synchronization search occasion at the apparatus is within a duration of a sidelink measurement for reference signals from the set of devices,
the next synchronization search occasion at the apparatus is within a configured time duration,
a reference signal received power for a current synchronization reference device of the apparatus is below a first reference signal received power threshold,
a synchronization priority of the current synchronization reference device is below a first priority threshold,
a reference signal received power for a candidate synchronization reference device of the apparatus is above a second reference signal received power threshold,
a synchronization priority of the candidate synchronization reference device is above a second priority threshold,
a clock-drift performance at the apparatus is below a performance threshold, and
a difference between a first time reference before a change of a time reference and a second time reference after the change of the time reference is to be above a difference threshold;
based on a determination that the reference signal transmission alignment among the set of devices is needed, transmitting, to the set of devices, a request for the reference signal transmission alignment for triggering the reference signal transmission alignment wherein the request for the reference signal transmission alignment is transmitted in a sidelink positioning protocol message and a sidelink control information, and wherein the request for the reference signal transmission alignment comprises: an indication for triggering the reference signal transmission alignment, a time reference point for a transmission time window, and time window information indicating a start point and an end point of the transmission time window from the time reference point;
receiving, from at least one device in the set of devices, a reference signal as per transmission time window that is determined by the at least one device based on a request for the reference signal transmission alignment; and
performing a measurement using the received reference signal.

77. The method of claim 76, wherein determining that the reference signal alignment among the set of devices is needed, is based further on a reference time change possibility within a duration of a sidelink measurement for reference signals from the set of devices.

78. The method of claim 77, further comprising, based on the determination that the reference signal transmission alignment among the set of devices is needed, informing another device that the reference signal transmission alignment among the set of devices is needed.

79. The method of claim 78, wherein the time reference point comprises a reception time point of the request for the reference signal transmission alignment, or
wherein the time reference point comprises a reception time point of a sidelink signal from one or more devices of the set of devices.

80. The method of claim 79, wherein the request for the reference signal transmission alignment further comprises:
source identity information of the set of devices, and
destination identity information used by the set of devices.

81. The method of claim 80, further comprising
performing a positioning estimation of the apparatus based on the measurement of the received reference signal; and
transmitting, to another device, a report indicating the measurement of the received reference signal.
